(19) United States
(12) Patent Application Publication
(10) Pub. No.: US 2018/0207048 A1
(43) Pub. Date: Jul. 26, 2018

(54) Scoliosis Treatment Platform and Method

(71) Applicant: ScoliWRx Inc., Campbell, CA (US)

(72) Inventor: Matthew I. Janzen, Campbell, CA (US)

(21) Appl. No.: 15/880,485

(22) Filed: Jan. 25, 2018

Related U.S. Application Data
(60) Provisional application No. 62/450,746, filed on Jan. 26, 2017.

(51) Int. Cl. A61H 1/02

(52) U.S. Cl. CPC A61H 1/0292; A61H 2203/0431; A61H 2201/1253; A61H 2201/0192; A61H 2201/1215; A61H 2201/5069; A61H 2201/169; A61H 2201/1621; A61H 2201/5061; A61H 2201/5064; A61H 2201/5007

(57) ABSTRACT

A scoliosis treatment platform includes a seat and leg structures connected to the seat. The leg structures are configured to support the seat in a substantially horizontal orientation at a vertical position above a base upon which the leg structures are positioned. The scoliosis treatment platform also includes a frame member positioned at a fixed location relative to the seat. The frame member extends upward above the seat. The scoliosis treatment platform also includes an actuator assembly connected to the frame member. The actuator assembly includes a cushion oriented toward a region overlying the seat. The actuator assembly is configured to apply a specified force through the cushion to a specified anatomical portion of a patient when the patient is seated on the seat.

### CLAIM OF PRIORITY

This application claims priority under 35 U.S.C. 119(e) to U.S. Provisional Patent Application No. 62/450,746, filed Jan. 26, 2017, the disclosure of which is incorporated herein by reference in its entirety for all purposes.

### BACKGROUND

The field of invention is devices, and methods that deploy such devices, to correct spinal deformities, in particular spinal scoliosis. Braces and Schroth exercise routines are the standard conservative intervention in scoliosis. Further, braces and the German-developed Schroth exercises have been used separately and together to correct various types of curvatures of the spine, known as scoliosis. Some conditions cannot be fully corrected, and if they progress may necessitate spinal surgery procedures, including fusion and/or the implantation of medical devices to internally support the spine in a correct position. Hence, it is desirable to provide corrective methods to patients to avoid future surgical intervention which poses risks, expense and at least temporary absence of the patient from work and/or school.

However, some types of scoliosis are resistant to correction with prior Schroth exercises and braces, and only partial correction can be achieved. It is generally understood that once scoliosis has occurred, flexibility of the spine can decrease, which limits the ability to correct the scoliosis. In some cases, flexibility of the spine can decrease by a process known as contracture in which ligaments and other soft tissue, once compressed or strained to an abnormal degree tend to set in that configuration, and become resistant to actions to restore them to the normal state.

Accordingly, there is a need for improved non-surgical care, braces and exercise routines that more effectively prevent and arrest progressive scoliosis, as well as treat scoliosis. It is also of interest to have methods for scoliosis treatment that overcome the limitations imposed by contracture. It is also of interest to have methods for scoliosis treatment that more effectively and rapidly reverse scoliosis once it has occurred and help patients return to a normal posture and flexibility.

### SUMMARY

In an example embodiment, a scoliosis treatment platform is disclosed. The scoliosis treatment platform includes a seat and leg structures connected to the seat. The leg structures are configured to support the seat in a substantially horizontal orientation at a vertical position above a base upon which the leg structures are positioned. The scoliosis treatment platform includes a frame member positioned at a fixed location relative to the seat. The frame member extends upward above the seat. The scoliosis treatment platform also includes an actuator assembly connected to the frame member. The actuator assembly includes a cushion oriented toward a region overlying the seat. The actuator assembly is configured to apply a specified force through the cushion to a specified anatomical portion of a patient when the patient is seated on the seat.

### BRIEF DESCRIPTION OF THE DRAWINGS

FIG. 1A shows a top view of a scoliosis treatment platform, in accordance with some embodiments of the present invention.

FIG. 1B shows a front view of the scoliosis treatment platform, in accordance with some embodiments of the present invention.

FIG. 1C shows a side view of the scoliosis treatment platform, in accordance with some embodiments of the present invention.

FIG. 2A shows a top view of an actuator assembly that includes a cushion attached to a support base, in accordance with some embodiments of the present invention.

FIG. 2B shows a side view of a coupling between the frame member and the lateral seat, in accordance with an example embodiment.

FIG. 3 shows a front view of the scoliosis treatment platform with the patient present within the scoliosis treatment platform, in accordance with some embodiments of the present invention.

FIG. 4 shows a view from the right side of the scoliosis treatment platform with the patient present within the scoliosis treatment platform as shown in FIG. 3, in accordance with some embodiments of the present invention.

FIG. 5 shows the scoliosis treatment platform with the additional upright structure and with the patient using the additional upright structure to perform an example stretching exercise, in accordance with some embodiments of the present invention.

FIG. 6 shows the scoliosis treatment platform and an additional upright structures attached to a base above the floor, in accordance with some embodiments of the present invention.

### DETAILED DESCRIPTION

In the following description, numerous specific details are set forth in order to provide an understanding of the present invention. It will be apparent, however, to one skilled in the art that the present invention may be practiced without some or all of these specific details. In other instances, well known process operations have not been described in detail in order not to unnecessarily obscure the present invention.

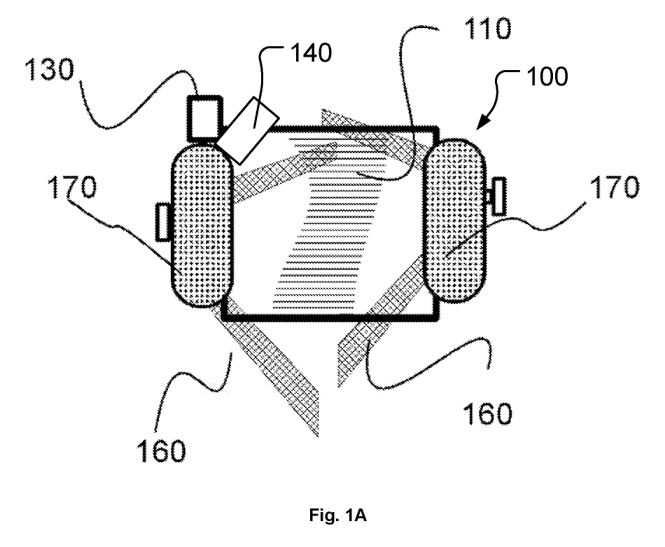

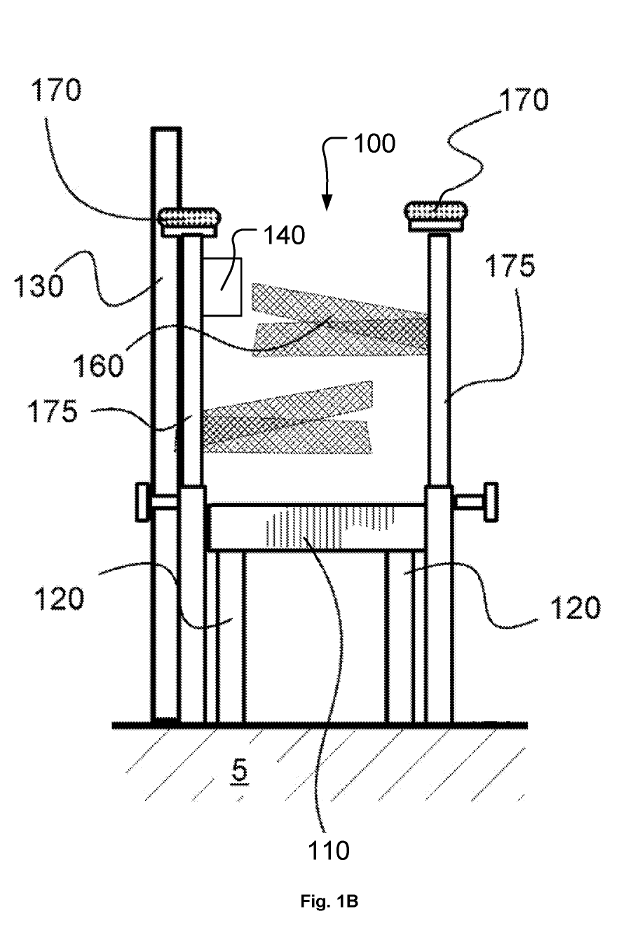

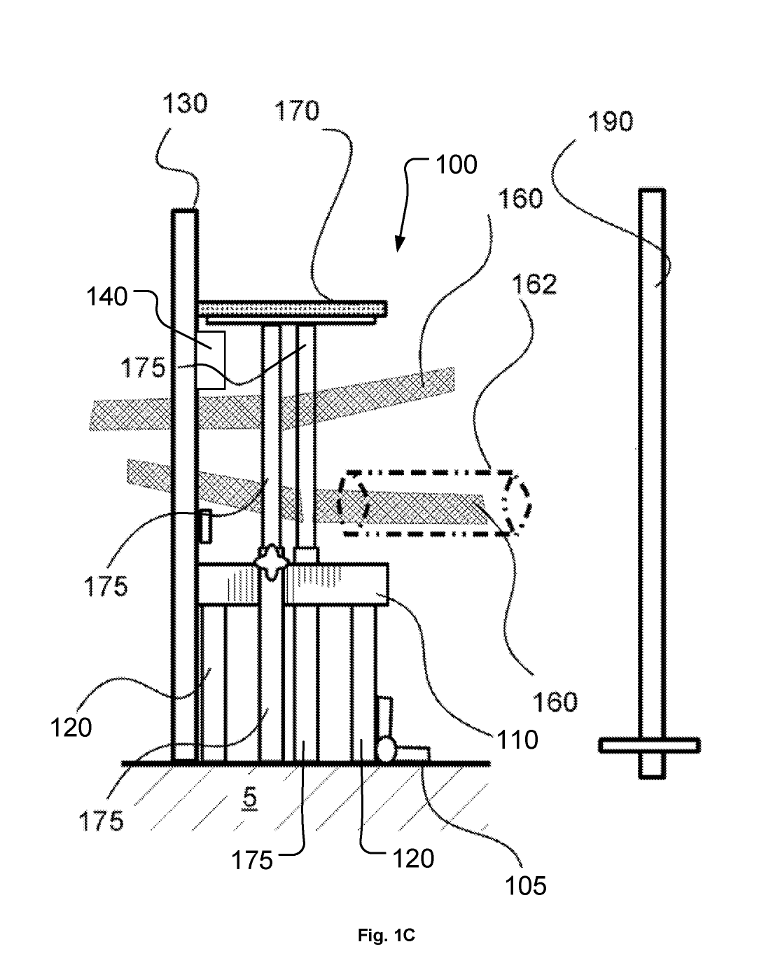

FIG. 1A shows a top view of a scoliosis treatment platform 100, in accordance with some embodiments of the present invention. FIG. 1B shows a front view of the scoliosis treatment platform 100, in accordance with some embodiments of the present invention. FIG. 1C shows a side view of the scoliosis treatment platform 100, in accordance with some embodiments of the present invention. The scoliosis treatment platform 100 includes a lateral seat 110 and legs 120 to hold the seat above a floor 5. The scoliosis treatment platform 100 can also include arm rest platforms 170 connected to vertical supports 175 on opposing sides of the lateral seat 110. The arm rest platforms 170 extend horizontally/laterally to provide structures upon which a patient 10 can rest their arms. In various embodiments, the arm rest platforms 170 can be padded for the comfort of the patient 10. Also, in some embodiments, the vertical supports 175 can be vertically adjustable to enable appropriate vertical positioning of the arm rest platforms 170 relative to the patient 10 when the patient is present within the scoliosis treatment platform 100. For example, in some embodiments, the vertical supports 175 can be telescoping posts coupled to the scoliosis treatment platform 100. In various embodiments, the vertical supports 175 can be connected to the lateral seat 110 and/or legs 120. In some embodiments, one arm rest platform 170 and corresponding vertical support 175 is connected to the scoliosis treatment platform 100.

One or more frame members 130 are coupled in an upright orientation to at least one of the lateral seat 110 and the legs 120. One or more cushions 140 can be connected to the one or more frame members 130. The cushions 140 can be configured to conform to a body of a patient 10 and apply a force to the body of the patient 10. Each cushion 140 can be positioned and oriented to extend toward the patient 10 from a location where the cushion 140 connects to the frame member 130. Each cushion 140 can be adjusted as needed to adjust a location of the cushion 140 relative to the patient 10 and a direction of force applied to the patient 10 by the cushion 140.

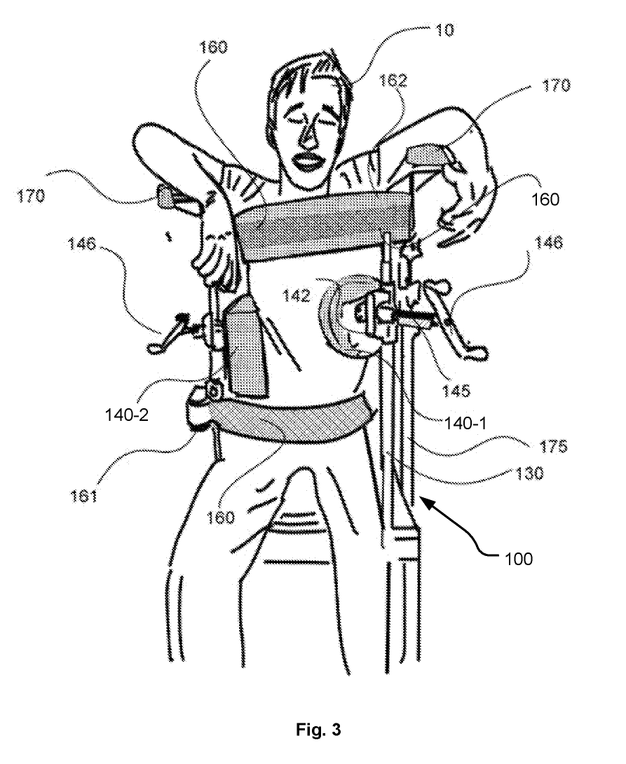

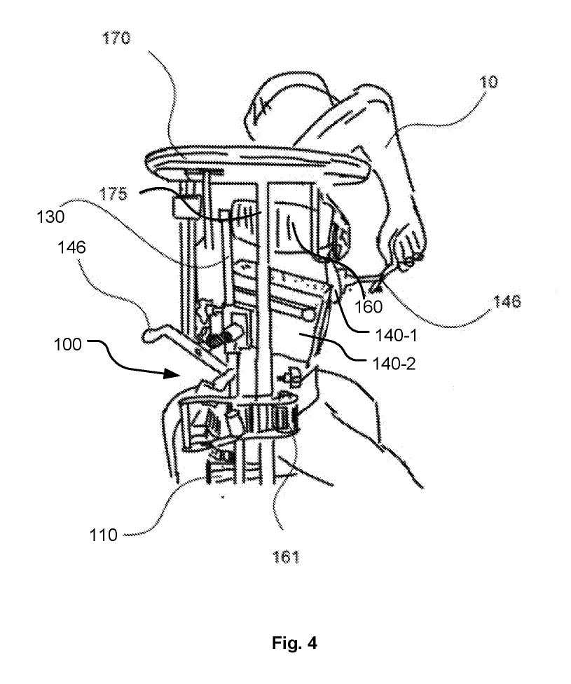

The scoliosis treatment platform 100 can also include one or more straps 160 configured to extend around the patient 10 when present within the scoliosis treatment platform 100 and tighten onto specific locations on the body of the patient 10. The strap(s) 160 can be positioned to apply forces through the thoracic cage of the patient 10 to specific vertebrae to assist with reversal of the scoliotic spinal curvature of the patient 10. In this manner, connection of strap 160 to the scoliosis treatment platform 100 on the right side of the patient 10 provides for application of a corrective force by the strap 160 into the left side of the patient 10. And, conversely, connection of strap 160 to the scoliosis treatment platform 100 on the left side of the patient 10 provides for application of a corrective force by the strap 160 into the right side of the patient 10. In various embodiments, the straps 160 can be connected to the lateral seat 110 and/or to one or more the legs 120 and/or to one or more frame members 130 and/or to another rigid structure of the scoliosis treatment platform 100. Also, in various embodiments, the vertical position of each strap 160 can be set as needed to treat a particular patient 10. Also, in some embodiments, a given strap 160 can be equipped with a corresponding ratcheting lever 161 (see FIGS. 3 and 4) to enable tightening of the given strap 160. And, in some embodiments, a given strap 160 can be fitted with a padding 162 (see FIGS. 1C and 3) to provide increased comfort to the patient 10 and/or to assist with focusing of a force applied from the given strap 160 to the body of the patient 10. In various embodiments, the padding 162 can be padded tubing, or an elongated cushion (possible with loops or velcro to secure to the strap 160), or essentially any other form of padding 162 that can be secured to the strap 160 and that does not interfere with application of a desired force from the strap 160 to the body of the patient 10.

In some embodiments, the legs 120 provide a support or union for various means to tilt the scoliosis treatment platform 100 relative to the floor 5. In various embodiments, the means to tilt the scoliosis treatment platform 100 relative to the floor 5 can include a hinge 105 connected between the scoliosis treatment platform 100 and the floor 5, or connected between the scoliosis treatment platform 100 and a horizontal platform set on the floor 5, where the horizontal platform generally grips the floor 5 to avoid sliding on the floor 5. In some embodiments, the means to tilt the scoliosis treatment platform 100 relative to the floor 5 can include one or more structures that extend horizontally outward from the scoliosis treatment platform 100, where the one or more structures provide a pivot structure about which the scoliosis treatment platform 100 can be tilted. In various embodiments, the means to tilt the scoliosis treatment platform 100 relative to the floor 5 can be configured to enable tilting of the scoliosis treatment platform 100 backward relative to an orientation of the patient 10 within the scoliosis treatment platform 100. Also, in various embodiments, the means to tilt the scoliosis treatment platform 100 relative to the floor 5 can also include means to rotate the scoliosis treatment platform 100 to either side in combination with the tilting. It should be understood that with the tilting and rotation of the scoliosis treatment platform 100, the patient 10 secured within the scoliosis treatment platform 100 can be positioned in a reclined orientation relative to the floor 5 with possible rotation of the patient 10 either to the left or right, where the reclined orientation can be at essentially any angle. In various embodiments, tilting of the scoliosis treatment platform 100 can occur before or after or in combination with rotation of the scoliosis treatment platform 100.

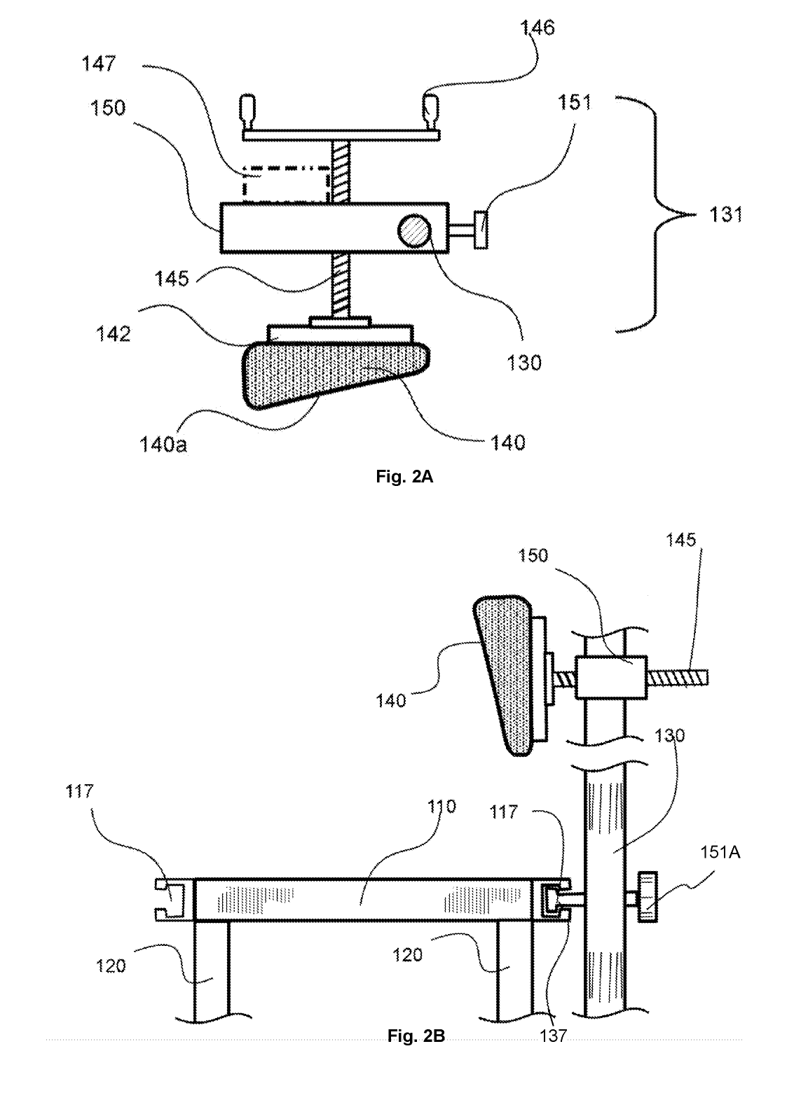

FIG. 2A shows a top view of an actuator assembly 131 that includes a cushion 140 attached to a support base 150, in accordance with some embodiments of the present invention. The support base 150 is configured to attach to one of the frame members 130. In some embodiments, the support base 150 is configured to be adjustably positioned along the frame member 130 and held at a desired position along the frame member 130 by a locking mechanism 151. In some embodiments, the frame member 130 includes a recessed track or rail that is engaged by a portion of the support base 150 to facilitate movement of the support base 150 along the frame member 130. In some example embodiments, the locking mechanism 151 can be a set screw, or pin member, or other component that functions to hold the support base 150 at a fixed position along the frame member 130. It should be understood that the desired position at which the support base 150 is fixed along the frame member 130 is set so that the cushion 140 that is attached to the support base 150 will contact the patient 10 at a prescribed location when the patient 10 is present within the scoliosis treatment platform 100.

In the example embodiment of FIG. 2A, the cushion 140 is attached to a backing member 142, and the backing member 142 is connected to the support base 150 by a horizontal support 145. In some embodiments, the horizontal support 145 is configured to provide for horizontal adjustment of the cushion 140 relative to the support base 150, so as to enable adjustable horizontal/lateral positioning of the cushion 140 relative to the patient 10 when the patient 10 is present within the scoliosis treatment platform 100. In this manner, the vertical, and horizontal/lateral, and angular positions of the cushion 140 relative to the patient 10 can be adjusted to apply a prescribed corrective force from the cushion 140 to the patient 10. In some embodiments, such as shown in the example of FIG. 2A, the horizontal support 145 is configured to have exterior screw threading that can be rotated through corresponding screw threading within the support base 150. In some embodiments, such as shown in the example of FIG. 2A, a handle member 146 is connected to the horizontal support 145 to provide for manual rotation of the horizontal support 145 so that the exterior screw threading of the horizontal support 145 can be rotated through the corresponding screw threading within the support base 150 to enable horizontal/lateral adjustment of the cushion 140 relative to the patient 10. In some embodiments, a controllable electronic motor 147 can be connected through mechanical linkage, such as gears and/or shafts and/or belts and/or chain, etc., to the horizontal support member 145 to provide electro-mechanical control of the horizontal/lateral adjustment of the cushion 140 relative to the patient 10.

FIG. 2B shows a side view of a coupling between the frame member 130 and the lateral seat 110, in accordance with an example embodiment. The coupling includes a rail structure 117 connected to the lateral seat 110 and a rail engagement fitting 137 connected to the frame member 130. The rail engagement fitting 137 can be moved to a desired position along the rail structure 117, and can be held at the desired position by a locking mechanism 151A. In some example embodiments, the locking mechanism 151A can be a set screw, or pin member, or other component that functions to hold the rail engagement fitting 137 at the desired position along the rail structure 117. In some embodiments, multiple frame members 130 can be positioned around the scoliosis treatment platform 100 to enable positioning of multiple cushions 140 around the scoliosis treatment platform 100 relative to the patient 10 when the present within the scoliosis treatment platform 100. For example, multiple rail structures 117 can be connected to the lateral seat 110 and/or legs 120 at different locations around the scoliosis treatment platform 100 to receive rail engagement fittings 137 for corresponding frame members 130, with multiple actuator assemblies 131 respectively connected to the frame members 130. In this manner, multiple cushions 140 can be positioned on opposing sides of the patient 10 to provide therapeutic scoliosis treatments.

In some embodiments, the cushions 140 can be fitted with an external surface or cover 140a (as shown in FIG. 2A) that is configured to generally spatially conform with a particular anatomical portion (body exterior contour as defined by skeletal and soft tissue features) of the patient 10 in either two-dimensions (2D) or three-dimensions (3D). In some embodiments, the external surface or cover 140a has a 2D or 3D shape that conforms with the particular anatomical portion of the patient 10. In some embodiments, the cushion 140 has a 2D or 3D shape that conforms with the particular anatomical portion of the patient 10. In some embodiments, the cushion 140 is supported on a substrate that has a 2D or 3D shape that conforms with the particular anatomical portion of the patient 10, with the substrate affixed to the backing member 142. In some embodiments, the backing member 142 has a 2D or 3D shape that conforms with the particular anatomical portion of the patient 10, with the cushion 140 positioned on the backing member 142. In some embodiments, a pliability of the cushion 140 can be graded, such that a lower pad of the cushion 140 (farther from the patient 10) has a 2D or 3D shape that conforms with the particular anatomical portion of the patient 10, and with a softer pad overlying the lower pad of the cushion 140 for contact with the patient 10. It should be understood that the shape and/or conformability of the cushion 140 can provide increased comfort to the patient 10, and/or provide for application of corrective forces to the patient 10 to assist with reversal of the scoliotic spinal curvature of the patient 10, and/or provide a restraint against movement of particular portion(s) of the body of the patient 10. It should be understood that multiple cushions 140 of prescribed 2D or 3D shape can be disposed at essentially any position on the body of the patient 10 when the patient 10 is present within the scoliosis treatment platform 100 for treatment. In some embodiments, multiple cushions 140 are disposed on opposing side of the patient to provide therapeutic treatments to assist with reversal of the scoliotic spinal curvature of the patient 10.

For example, FIG. 3 shows a front view of the scoliosis treatment platform 100 with the patient 10 present within the scoliosis treatment platform 100, in accordance with some embodiments of the present invention. FIG. 4 shows a view from the right side of the scoliosis treatment platform 100 with the patient 10 present within the scoliosis treatment platform 100 as shown in FIG. 3, in accordance with some embodiments of the present invention. In the example of FIGS. 3 and 4, a cushion 140-1 is positioned on a left side of the patient 10, and a cushion 140-2 is positioned on a right side of the patient 10. Also, the cushion 140-1 is positioned at a higher vertical location along the spinal column of the patient 10 than the cushion 140-2. Also, the cushion 140-1 is positioned at a more anterior location on the patient 10 as compared with the cushion 140-2. In this manner, the cushion 140-1 may be positioned to treat a thoracic scoliotic curvature, while the cushion 140-2 may be positioned to treat a thoraco-lumbar and/or lumbar scoliotic curvature.

In various embodiments, any of the cushions 140 and/or straps 160 of the scoliosis treatment platform 100 can be connected to a corresponding controllable electronic actuator, e.g., motor, such as described with regard to FIG. 2A, through appropriately configured mechanical linkage, such as gears and/or shafts and/or belts and/or chain, etc., to provide electro-mechanical control of forces applied by the cushions 140 and/or straps 160 to the patient 10. In some embodiments, the controllable electronic actuators of the cushions 140 and/or straps 160 can be placed under automated and/or programmed control by way of controller device that may be a computer system, or programmable logic controller (PLC), or microprocessor, or other type of computing device. In some embodiments, the controller device is configured to receive input signals from one or more sensors deployed on the scoliosis treatment platform 100 and/or patient 10, and in response to the input signals, control the controllable electronic actuators of the cushions 140 and/or straps 160. In some embodiments, the controllable electronic actuators of the cushions 140 and/or straps 160 are controlled to cause the cushions 140 and/or straps 160 to apply a prescribed force to the body of the patient 10. In some embodiments, the controllable electronic actuators of the cushions 140 and/or straps 160 are controlled to cause the cushions 140 and/or straps 160 to move a prescribed distance in a prescribed direction relative to the body of the patient 10.

In some embodiments, the controllable electronic actuators of the cushions 140 and/or straps 160 are controlled to cause the cushions 140 and/or straps 160 to move in accordance with a prescribed exercise/treatment regime. In some embodiments, the controllable electronic actuators of the cushions 140 and/or straps 160 are controlled to automatically implement a timed application of force to the body of the patient 10, where the timed application of force can be either a constant application of force over a period of time or a cyclic application of force over a period of time. In some embodiments, the controllable electronic actuators of the cushions 140 and/or straps 160 are controlled to automatically implement a timed application of movement of the cushions 140 and/or straps 160 relative the body of the patient 10, where the timed application of movement can be either a constant amount of movement over a period of time or a cyclic amount of movement over a period of time. In some embodiments, one or more force sensors can be associated with a given controllable electronic actuator of the cushions 140 and/or straps 160 to provide for real-time monitoring of force applied to the patient 10. In some embodiments, one or more displacement/movement sensors can be associated with a given controllable electronic actuator of the cushions 140 and/or straps 160 to provide for real-time monitoring of displacement/movement of the cushion 140 and/or straps 160 relative to the body of the patient 10. In some embodiments, limit switches can be implemented with the controllable electronic actuators of the cushions 140 and/or straps 160 to provide safety limits on forces applied to the patient 10 by the cushions 140 and/or straps 160. In some embodiments, different limit switches for different controllable electronic actuators of the cushions 140 and/or straps 160 can be individually set according to the location of the cushions 140 and/or straps 160 and/or the physical characteristics of the patient 10. In some embodiments, the controllable electronic actuators of some of the cushions 140 and/or straps 160 are configured to provide a force through the cushions 140 and/or straps 160 to the patient 10 within a range extending from about 50 pounds of applied force to about 200 pounds of applied force. In some embodiments, the controllable electronic actuators of some of the cushions 140 and/or straps 160 are configured to provide a force through the cushions 140 and/or straps 160 to the patient 10 within a range extending up to about 50 pounds. In some embodiments, the controllable electronic actuators of some of the cushions 140 and/or straps 160 are configured to provide a force through the cushions 140 and/or straps 160 to the patient 10 that exceeds about 200 pounds of applied force. In some embodiments, the controllable electronic actuators of some of the cushions 140 and/or straps 160 are configured to provide an applied force to the patient 10 over a distance of movement of the cushions 140 and/or straps 160 within a range extending from about 4 inches to about 8 inches, or within a range extending from about 10 centimeters to about 20 centimeters. In some embodiments, the controllable electronic actuators of some of the cushions 140 and/or straps 160 are configured to provide an applied force to the patient 10 over a distance of movement of the cushions 140 and/or straps 160 less than about 4 inches, or less than about 10 centimeters. In some embodiments, the controllable electronic actuators of some of the cushions 140 and/or straps 160 are configured to provide an applied force to the patient 10 over a distance of movement of the cushions 140 and/or straps 160 greater than about 8 inches, or greater than about 20 centimeters.

In some embodiments, the scoliosis treatment platform 100 includes a means for manual release/disengagement or hand release/disengagement of any controllable electronic actuator of the cushions 140 and/or straps 160. In some embodiments, the scoliosis treatment platform 100 includes a means for safe manual retraction by hand of any cushions 140 and/or straps 160 away from the patient 10, including of any cushions 140 and/or straps 160 connected to a controllable electronic actuator, in case of emergency.

In some embodiments, the controllable electronic actuators of the cushions 140 and/or straps 160 are configured to be taken out of gear through activation of a manual release. Also, in some embodiments, the controllable electronic actuators of the cushions 140 and/or straps 160 are configured to allow for manual retraction of the cushions 140 and/or straps 160 away from the patient 10 upon being taken out of gear through activation of a manual release. In some embodiments, the scoliosis treatment platform 100 includes a fail-safe release that provides for immediate disengagement/separation of any one or more of the controllable electronic actuators of the cushions 140 and/or straps 160 from the structure of the scoliosis treatment platform 100. For example, in some embodiments the controllable electronic actuators of the cushions 140 and/or straps 160 can be connected to the structure of the scoliosis treatment platform 100 through a release pin, so that when the release pin is removed (possible through activation of the fail-safe release), the corresponding controllable electronic actuators of the cushions 140 and/or straps 160 disengages/separates from the scoliosis treatment platform 100. Also, in some embodiments, the controllable electronic actuators of the cushions 140 and/or straps 160 can be configured to automatically release any applied pressure from the patient 10 in the event of power failure. For example, the controllable electronic actuators of the cushions 140 and/or straps 160 can be equipped with a solenoid that only engages the gears of the controllable electronic actuator when electrical power is present. Additionally, in some embodiments, any of the controllable electronic actuators of the cushions 140 and/or straps 160 can be equipped with motor speed controllers to limit how fast a cushion 140 and/or strap 160 can move relative to the patient 10.

In some embodiments, automation of the scoliosis treatment platform 100 can include provision of programming and user interfaces for entering, displaying, monitoring, and logging treatment and exercise routines. In some embodiments, a computing device is used to provide such programming and user interfaces for the scoliosis treatment platform 100. In various embodiments, the computing device can be a smartphone, a laptop computer, a tablet computer, a desktop computer, or essentially any other type of computer that includes an electronic display for showing a graphical user interface (GUI). In some embodiments, a GUI is provided to enable entering, displaying, monitoring, and logging treatment and exercise routine instructions and information. In some embodiments, the GUI can be used to set up an automated treatment routine. In some embodiments, the GUI can be used to provide coaching to the patient 10 as part of the treatment process. In some embodiments, various sensors deployed on the scoliosis treatment platform 100 can provide information to a computer system for monitoring and logging of how the scoliosis treatment platform 100 is operated/used, such as by monitoring and logging displacement/movement distance of the cushions 140 and/or straps 160 as a function of time and/or forces applied by the cushions 140 and/or straps 160 as a function of time. In some embodiments, the computer system for monitoring and logging of how the scoliosis treatment platform 100 is operated/used provides for display of distance/force/time goals versus distance/force/time data of an actual treatment session, either recorded or in real-time. Also, the GUI can be used by the care provider to monitor an/or set limits for the safe treatment using the scoliosis treatment platform 100. The GUI can also be used to set the duty cycle and/or power in any prescription that includes repetitive or vibratory or cyclic movement of the cushions 140 and/or straps 160 as a function of time. The logging during treatment of force applied through the cushions 140 and/or straps 160 and/or displacement/movement of the cushions 140 and/or straps 160 provides a useful metric of the energy required to gain compliance of transformation to and beyond a corrective spinal posture that corrects contracture. It is expected that less energy will be required to gain compliance of transformation to and beyond a corrective spinal posture as contracture is reduced due to the ligaments becoming more compliant from repetitive motion.

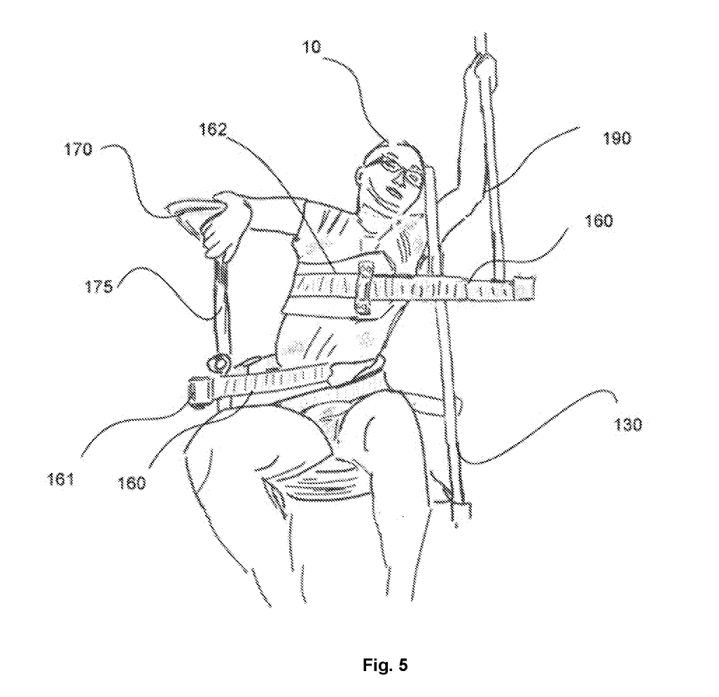

In some embodiments, the scoliosis treatment platform 100 can be used in conjunction with additional upright structures 190 positioned near the scoliosis treatment platform 100, where the additional upright structures 190 can be gripped and pulled upon by the patient 10 to perform stretching exercises. For example, FIG. 1C shows an example upright structure 190 positioned near the scoliosis treatment platform 100. In some embodiments, the additional upright structures 190 can be attached to the floor 5. In some embodiments, the additional upright structures 190 can be attached to the scoliosis treatment platform 100, such as by connection to the seat 110 and/or legs 120. FIG. 5 shows the scoliosis treatment platform 100 with the additional upright structure 190 and with the patient 10 using the additional upright structure 190 to perform an example stretching exercise, in accordance with some embodiments of the present invention.

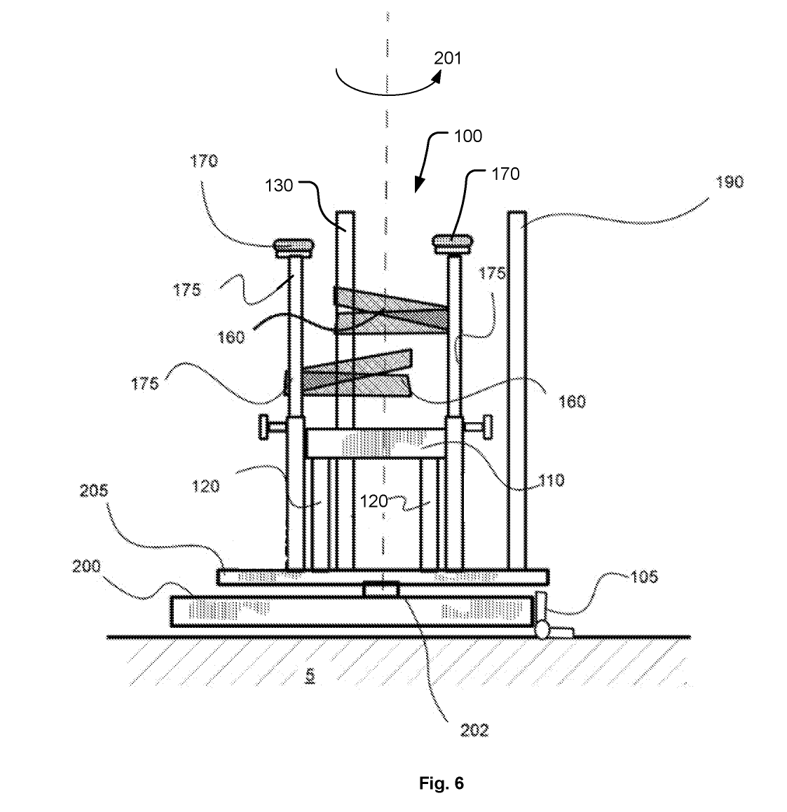

FIG. 6 shows the scoliosis treatment platform 100 and an additional upright structures 190 attached to a base 205 above the floor 5, in accordance with some embodiments of the present invention. The base 205 is attached to a pivot base 200 by a central support structure 202 that provides for controlled rotation of the base 205 about a central axis 201, so as to provide for controlled rotation of the scoliosis treatment platform 100 and an additional upright structures 190 about the central axis 201. The pivot base 200 is connected to the floor 5 by the hinge 105 so that the pivot base 200 can be tilted relative to the plane of the floor 5. It should be understood that one or more hinges 105 can be positioned to enable tilting of the pivot base 200 in any desired direction. In this configuration, as the pivot base 200 is tilted, the base 205 and the scoliosis treatment platform 100 and an additional upright structures 190 attached to the base 205 are also tilted. Therefore, it should be understood that in various embodiments, once the patient 10 is positioned within the scoliosis treatment platform 100 in a secured manner, the pivot base 200 can be tilted in a controlled manner and the base 205 can be rotated in a controlled manner to position the patient 10 in a prescribed orientation while corrective forces are being applied to the patient 10 by the scoliosis treatment platform 100 and possibly while the patient 10 is using the additional upright structures 190 to perform stretching exercises. The tilting and rotation of the scoliosis treatment platform 100 can be done to maximize use of gravity to assist in application of corrective forces to the patient 10 by the cushions 140 and/or straps 160 of the scoliosis treatment platform 100. It should be understood that correction of scoliosis using the scoliosis treatment platform 100, especially in the tilted and/or rotated orientation, differs significantly from use of static scoliosis braces that attempt to statically position the patient is a more correct spinal posture having a reduced scoliotic curvature. In some embodiments, use of the scoliosis treatment platform 100 in the tilted and/or rotated orientation with application of corrective forces using the cushions 140 and/or straps 160 can be done to leverage use of gravity to maximize straightening of the spinal column in a supine position or in a side lying position, to enable reversal of significant scoliotic spinal column translations/curves and encourage corresponding de-rotation of vertebrae.

In some embodiments, the scoliosis treatment platform 100 can be used in accordance with known principles of bracing for treating scoliosis. However, it should be understood that the scoliosis treatment platform 100 can also be used to provide a more aggressive application of force to the patient 10 to reverse ligament contractures than what is possible with a brace. The scoliosis treatment platform 100 can be used to stretch the spinal column in a substantially straight manner to target stubborn ligament contractures that resist/prevent the spinal column from returning to a normal straight configuration. The scoliosis treatment platform 100 enables a larger continuous stretch of the spinal column than what is possible to achieve with a brace. And, this larger continuous stretch of the spinal column that is possible with the scoliosis treatment platform 100 triggers remodeling of soft tissue so that the spinal column can achieve and retain a normal straight configuration. Treatment of scoliosis using the scoliosis treatment platform 100 can be done in combination with wearing of a corrective brace between treatments to provide for more rapid and longer term correction of scoliosis. The scoliosis treatment platform 100 can also be used to assist with placing a patient 10 in corrective positions that are used in Schroth therapy or auto-correction scoliosis exercises. The scoliosis treatment platform 100 can also be used to assist with maximizing the Schroth-based use of breathing, also known as right-angled breathing. It should be understood that the scoliosis treatment platform 100 is a corrective platform from which the patient 10 can perform their auto-corrective exercises.

Specific details of how the scoliosis treatment platform 100 is used to treat a given patient 10 is determined by the unique size and physique of the patient 10 and by the type and degree of scoliosis that afflicts the patient 10. The patient 10 is seated within the scoliosis treatment platform 100 and an appropriate combination of forces is applied to the patient 10 from one or more of the cushions 140 and/or straps 160 to move the spinal column of the patient 10 from the scoliotic configuration toward the normal straight configuration. The combination of forces applied to the patient 10 from one or more of the cushions 140 and/or straps 160 can vary over time as treatment progresses and as the spinal column of the patient 10 becomes more pliable and adjusts toward the normal straight configuration.

In some embodiments, the scoliosis treatment platform 100 is configured to apply a corrective lateral force to the patient 10 from a strap 160 in conjunction with application of a corrective force to the patient 10 from a cushion 140, wherein the corrective forces applied by the strap 160 and cushion 140 are directed to different parts of the spinal column of the patient 10. In some embodiments, the corrective force applied to the patient 10 by the cushion 140 serves to at least partially reverse the contracture of spinal ligaments. In some embodiments, the strap 160 and the cushion 140 are configured on the scoliosis treatment platform 100 to apply substantially opposing forces to the spinal column of the patient 10.

The scoliosis treatment platform 100 and associated scoliosis treatment methods provide for application of higher corrective forces than what can be applied with weight braces. Also, the scoliosis treatment platform 100 and associated scoliosis treatment methods provide for simultaneous application of different force components to the patient 10, which provides for accelerated correction of scoliotic spinal curvature.

In an example embodiment, a scoliosis treatment platform (e.g., 100) is disclosed. The scoliosis treatment platform (e.g., 100) includes a seat (e.g., 110) and leg structures (e.g., 120) connected to the seat (e.g., 110). The leg structures (e.g., 120) are configured to support the seat (e.g., 110) in a substantially horizontal orientation at a vertical position above a base (e.g., 5, 205) upon which the leg structures (e.g., 120) are positioned. The scoliosis treatment platform (e.g., 100) includes a frame member (e.g., 130) positioned at a fixed location relative to the seat (e.g., 110). The frame member (e.g., 130) extends upward above the seat (e.g., 110). In some embodiments, the fixed position of the frame member (e.g., 130) relative to the seat (e.g., 110) is adjustable. The scoliosis treatment platform (e.g., 100) also includes an actuator assembly (e.g., 131) connected to the frame member (e.g., 130). The actuator assembly (e.g., 131) includes a cushion (e.g., 140) oriented toward a region overlying the seat (e.g., 110). The actuator assembly (e.g., 131) is configured to apply a specified force through the cushion (e.g., 140) to a specified anatomical portion of a patient (e.g., 10) when the patient is seated on the seat (e.g., 110).

In some embodiments, the scoliosis treatment platform (e.g., 100) includes a strap (e.g., 160) connected to one or more of the seat (e.g., 110), the leg structures (e.g., 120), and the at least one frame member (e.g., 130). The strap (e.g., 120) is configured to extend around the patient (e.g., 10) and apply a specified force to a specified anatomical portion of the patient (e.g., 10) when the patient is seated on the seat (e.g., 110). In some embodiments, a portion of the strap (e.g., 160) that contacts the patient (e.g., 10) is fitted with a padding material (e.g., 162), such that the padding material (e.g., 162) is positioned between the strap (e.g., 160) and the patient (e.g., 10). In some embodiments, a ratcheting lever (e.g., 161) is connected to one or more of the seat (e.g., 110), the leg structures (e.g., 120), and the at least one frame member (e.g., 130). The ratcheting lever (e.g., 161) is configured to provide for tightening of the strap (e.g., 160) to apply the specified force to the specified anatomical portion of the patient (e.g., 10) when the patient is seated on the seat (e.g., 110). In some embodiments, the actuator assembly (e.g., 131) and the strap (e.g., 160) are connected to the scoliosis treatment platform (e.g., 100) on opposite sides of the scoliosis treatment platform (e.g., 100).

In some embodiments, the actuator assembly (e.g., 131) is configured to move along the frame member (e.g., 130) to a prescribed position, and the actuator assembly (e.g., 131) is configured to maintain the prescribed position on the frame member (e.g., 130). In some embodiments, the actuator assembly (e.g., 131) is configured to position the cushion (e.g., 140) in a prescribed three-dimensional orientation at a prescribed position within the region overlying the seat (e.g., 110). In some embodiments, a portion of the cushion (e.g., 140) that is configured to contact the patient (e.g., 10) has a shape that substantially matches a shape of the specified anatomical portion of the patient (e.g., 10) to which the specified force is applied through the cushion (e.g., 140).

In some embodiments, the actuator assembly (e.g., 131) includes a cushion movement mechanism (e.g., 145, 146, 147) configured to move the cushion (e.g., 140) in a controlled manner toward the patient (e.g., 10) and away from the patient (e.g., 10) when the patient is seated on the seat (e.g., 110). In some embodiments, the cushion movement mechanism (e.g., 145, 146, 147) is manually controlled. In some embodiments, the cushion movement mechanism (e.g., 145, 146, 147) is electronically controlled through a controllable electronic motor (e.g., 147). In some embodiments, the actuator assembly (e.g., 131) is configured to electronically communicate with a computer implemented control system that is configured to control operation of the controllable electronic motor (e.g., 147).

In some embodiments, the actuator assembly (e.g., 131) includes a release mechanism configured to move the cushion (e.g., 140) away from the patient (e.g., 10) when the patient is seated on the seat (e.g., 110). In some embodiments, the release mechanism is manually activatable, or electronically activatable, or both manually and electronically activatable. In some embodiments, at least one sensor (force sensor) is/are positioned and configured to measure force applied through the cushion (e.g., 140) to the specified anatomical portion of the patient (e.g., 10) when the patient is seated on the seat (e.g., 110). In some embodiments, the at least one force sensor is configured to electronically communicate with a computer implemented control system. In some embodiments, at least one sensor (location/orientation sensor) is/are positioned and configured to measure a location and an orientation of the cushion (e.g., 140) relative to the seat (e.g., 110). In some embodiments, the at least one location/orientation sensor is configured to electronically communicate with a computer implemented control system.

In some embodiments, the scoliosis treatment platform includes one arm rest platform (e.g., 170). For example, in some embodiments, a vertical support (e.g., 175) is connected to one or more of the seat (e.g., 110), the leg structures (e.g., 120), and the at least one frame member (e.g., 130). And, an arm rest platform (e.g., 170) is connected to the vertical support (e.g., 175). In some embodiments, the scoliosis treatment platform includes two arm rest platforms (e.g., 170). For example, in some embodiments, a first vertical support (e.g., 175) is connected to one or more of the seat (e.g., 110), the leg structures (e.g., 120), and the at least one frame member (e.g., 130). And, a first arm rest platform (e.g., 170) is connected to the first vertical support (e.g., 175). And, a second vertical support (e.g., 175) is connected to one or more of the seat (e.g., 110), the leg structures (e.g., 120), and the at least one frame member (e.g., 130). And, a second arm rest platform (e.g., 170) is connected to the second vertical support (e.g., 175). The first arm rest platform (e.g., 170) and second arm rest platform (e.g., 170) are positioned on opposite sides of the scoliosis treatment platform (e.g., 100). Also, in some embodiments, an upright structure (e.g., 190) is positioned near the scoliosis treatment platform (e.g., 100). The upright structure (e.g., 190) is positioned and configured to be gripped and pulled upon by the patient (e.g., 10) when the patient is seated on the seat (e.g., 110).

In some embodiments, the scoliosis treatment platform (e.g., 100) includes a first frame member (e.g., 130), and a first actuator assembly (e.g., 131) connected to the first frame member (e.g., 130), and a first cushion (e.g., 140) connected to the first actuator assembly (e.g., 131), a second frame member (e.g., 130), and a second actuator assembly (e.g., 131) connected to the second frame member (e.g., 130), and a second cushion (e.g., 140) connected to the second actuator assembly (e.g., 131). The first and second frame members (e.g., 130) are positioned at respective fixed locations relative to the seat (e.g., 110). Both of the first and second frame members (e.g., 130) extend upward above the seat (e.g., 110). Each of the first and second cushions (e.g., 140) is oriented toward the region overlying the seat (e.g., 110). The first actuator assembly (e.g., 131) is configured to apply a specified force through the first cushion (e.g., 140) to a specified anatomical portion of the patient (e.g., 10) when the patient is seated on the seat (e.g., 110). And, the second actuator assembly (e.g., 131) is configured to apply a specified force through the second cushion (e.g., 140) to a specified anatomical portion of the patient (e.g., 10) when the patient is seated on the seat (e.g., 110). In some embodiments, the first actuator assembly (e.g., 131) is positioned vertically closer to the seat (e.g., 110) than the second actuator assembly (e.g., 131). In some embodiments, the first actuator assembly (e.g., 131) is positioned to apply the first cushion (e.g., 140) to a first lateral side of the patient (e.g., 10) when the patient is seated on the seat (e.g., 110). And, the second actuator assembly (e.g., 131) is positioned to apply the second cushion (e.g., 140) to a second lateral side of the patient (e.g., 10) when the patient is seated on the seat (e.g., 110), where the second lateral side is opposite the first lateral side.

In some embodiments, the scoliosis treatment platform (e.g., 100) includes multiple straps (e.g., 160). For example, in some embodiments, the scoliosis treatment platform (e.g., 100) includes a first strap (e.g., 160) connected to one or more of the seat (e.g., 110), the leg structures (e.g., 120), and the at least one frame member (e.g., 130). The first strap (e.g., 160) is configured to extend around the patient (e.g., 10) and apply a specified force to a first specified anatomical portion of the patient (e.g., 10) when the patient is seated on the seat (e.g., 110). Also, a second strap (e.g., 160) is connected to one or more of the seat (e.g., 110), the leg structures (e.g., 120), and the at least one frame member (e.g., 130). The second strap (e.g., 160) is configured to extend around the patient (e.g., 10) and apply a specified force to a second specified anatomical portion of the patient (e.g., 10) when the patient is seated on the seat (e.g., 110). In some embodiments, the first and second specified anatomical portions of the patient (e.g., 10) are on opposite lateral sides of the patient (e.g., 10). In some embodiments, the first and second specified anatomical portions of the patient (e.g., 10) are on a same lateral side of the patient (e.g., 10). In some embodiments, a portion of the first strap (e.g., 160) that contacts the patient (e.g., 10) is fitted with a padding material (e.g., 162), such that the padding material (e.g., 162) is positioned between the first strap (e.g., 160) and the patient (e.g., 10). Also, in some embodiments, a portion of the second strap (e.g., 160) that contacts the patient (e.g., 10) is fitted with a padding material (e.g., 162), such that the padding material (e.g., 162) is positioned between the second strap (e.g., 160) and the patient (e.g., 10). In some embodiments, a first ratcheting lever (e.g., 161) is connected to one or more of the seat (e.g., 110), the leg structures (e.g., 102), and the at least one frame member (e.g., 130). The first ratcheting lever (e.g., 161) is configured to provide for tightening of the first strap (e.g., 160) to apply the specified force to the first specified anatomical portion of the patient (e.g., 10) when the patient is seated on the seat (e.g., 110). Also, a second ratcheting lever (e.g., 161) is connected to one or more of the seat (e.g., 110), the leg structures (e.g., 102), and the at least one frame member (e.g., 130). The second ratcheting lever (e.g., 161) is configured to provide for tightening of the second strap (e.g., 160) to apply the specified force to the second specified anatomical portion of the patient (e.g., 10) when the patient is seated on the seat (e.g., 110).

In some embodiments, the scoliosis treatment platform (e.g., 100) is configured to be tilted in a controlled manner relative to horizontal when the patient (e.g., 10) is seated on the seat (e.g., 110). And, in some embodiments, the scoliosis treatment platform (e.g., 100) is configured to be rotated in a controlled manner about a central axis of rotation (e.g., 201) that extends in a direction substantially perpendicular to a plane of the seat (e.g., 110) when the patient (e.g., 10) is seated on the seat (e.g., 110). It should be understood that the controlled rotation of the scoliosis treatment platform (e.g., 100) about the central axis of rotation (e.g., 201) can be done in conjunction with, i.e., simultaneously with, tilting of the scoliosis treatment platform (e.g., 100) relative to horizontal when the patient (e.g., 10) is seated on the seat (e.g., 110).

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in other embodiments, even if not specifically shown or described. Such variations of the example embodiments disclosed herein are not to be regarded as a departure from the invention, and all such modifications are intended to be included within the scope of the invention.

Although the foregoing invention has been described in some detail for purposes of clarity of understanding, it will be apparent that certain changes and modifications can be practiced within the scope of the invention description. Accordingly, the example embodiments disclosed herein are to be considered as illustrative and not restrictive, and the invention is not to be limited to the details given herein, but may be modified within the scope and equivalents of the described embodiments.

What is claimed is:

1. A scoliosis treatment platform, comprising:
a seat;
leg structures connected to the seat, the leg structures configured to support the seat in a substantially horizontal orientation at a vertical position above a base upon which the leg structures are positioned;
a frame member positioned at a fixed location relative to the seat, the frame member extending upward above the seat; and
an actuator assembly connected to the frame member, the actuator assembly including a cushion oriented toward a region overlying the seat, the actuator assembly configured to apply a specified force through the cushion to a specified anatomical portion of a patient when the patient is seated on the seat.

2. The scoliosis treatment platform as recited in claim 1, further comprising:
a strap connected to one or more of the seat, the leg structures, and the at least one frame member, the strap configured to extend around the patient and apply a specified force to a specified anatomical portion of the patient when the patient is seated on the seat.

3. The scoliosis treatment platform as recited in claim 2, wherein a portion of the strap that contacts the patient is fitted with a padding material, such that the padding material is positioned between the strap and the patient.

4. The scoliosis treatment platform as recited in claim 2, further comprising:
a ratcheting lever connected to one or more of the seat, the leg structures, and the at least one frame member, the ratcheting lever configured to provide for tightening of the strap to apply the specified force to the specified anatomical portion of the patient when the patient is seated on the seat.

5. The scoliosis treatment platform as recited in claim 2, wherein the actuator assembly and the strap are connected to the scoliosis treatment platform on opposite sides of the scoliosis treatment platform.

6. The scoliosis treatment platform as recited in claim 1, wherein the actuator assembly is configured to move along the frame member to a prescribed position, and wherein the actuator assembly is configured to maintain the prescribed position on the frame member.

7. The scoliosis treatment platform as recited in claim 6, wherein the actuator assembly is configured to position the cushion in a prescribed three-dimensional orientation at a prescribed position within the region overlying the seat.

8. The scoliosis treatment platform as recited in claim 1, wherein the actuator assembly is configured to position the cushion in a prescribed three-dimensional orientation at a prescribed position within the region overlying the seat.

9. The scoliosis treatment platform as recited in claim 1, wherein a portion of the cushion that is configured to contact the patient has a shape that substantially matches a shape of the specified anatomical portion of the patient to which the specified force is applied through the cushion.

10. The scoliosis treatment platform as recited in claim 1, wherein the fixed position of the frame member relative to the seat is adjustable.

11. The scoliosis treatment platform as recited in claim 1, wherein the actuator assembly includes a cushion movement mechanism configured to move the cushion in a controlled manner toward the patient and away from the patient when the patient is seated on the seat.

12. The scoliosis treatment platform as recited in claim 11, wherein the cushion movement mechanism is manually controlled.

13. The scoliosis treatment platform as recited in claim 11, wherein the cushion movement mechanism is electronically controlled through a controllable electronic motor.

14. The scoliosis treatment platform as recited in claim 13, wherein the actuator assembly is configured to electronically communicate with a computer implemented control system that is configured to control operation of the controllable electronic motor.

15. The scoliosis treatment platform as recited in claim 1, wherein the actuator assembly includes a release mechanism configured to move the cushion away from the patient when the patient is seated on the seat.

16. The scoliosis treatment platform as recited in claim 15, wherein the release mechanism is manually activatable, or electronically activatable, or both manually and electronically activatable.

17. The scoliosis treatment platform as recited in claim 1, further comprising:
at least one sensor positioned and configured to measure force applied through the cushion to the specified anatomical portion of the patient when the patient is seated on the seat.

18. The scoliosis treatment platform as recited in claim 17, wherein the at least one sensor is configured to electronically communicate with a computer implemented control system.

19. The scoliosis treatment platform as recited in claim 1, further comprising:
at least one sensor positioned and configured to measure a location and an orientation of the cushion relative to the seat.

20. The scoliosis treatment platform as recited in claim 19, wherein the at least one sensor is configured to electronically communicate with a computer implemented control system.

21. The scoliosis treatment platform as recited in claim 1, further comprising:
a vertical support connected to one or more of the seat, the leg structures, and the at least one frame member; and
an arm rest platform connected to the vertical support.

22. The scoliosis treatment platform as recited in claim 1, further comprising:
a first vertical support connected to one or more of the seat, the leg structures, and the at least one frame member;
a first arm rest platform connected to the first vertical support;
a second vertical support connected to one or more of the seat, the leg structures, and the at least one frame member; and
a second arm rest platform connected to the second vertical support, wherein the first and second arm rest platforms are positioned on opposite sides of the scoliosis treatment platform.

23. The scoliosis treatment platform as recited in claim 1, further comprising:
an upright structure positioned near the scoliosis treatment platform, the upright structure positioned and configured to be gripped and pulled upon by the patient when the patient is seated on the seat.

24. The scoliosis treatment platform as recited in claim 1, wherein the frame member is a first frame member, and wherein the actuator assembly is a first actuator assembly, and wherein the cushion of the first actuator assembly is a first cushion,
wherein the scoliosis treatment platform includes a second frame member positioned at a fixed location relative to the seat, the second frame member extending upward above the seat,
wherein the scoliosis treatment platform includes a second actuator assembly connected to the second frame member, the second actuator assembly including a second cushion oriented toward the region overlying the seat, the second actuator assembly configured to apply a specified force through the second cushion to a specified anatomical portion of the patient when the patient is seated on the seat.

25. The scoliosis treatment platform as recited in claim 24, wherein the first actuator assembly is positioned vertically closer to the seat than the second actuator assembly.

26. The scoliosis treatment platform as recited in claim 24, wherein the first actuator assembly is positioned to apply the first cushion to a first lateral side of the patient when the patient is seated on the seat, and
wherein the second actuator assembly is positioned to apply the second cushion to a second lateral side of the patient when the patient is seated on the seat, the second lateral side being opposite the first lateral side.

27. The scoliosis treatment platform as recited in claim 26, wherein the first actuator assembly is positioned vertically closer to the seat than the second actuator assembly.

28. The scoliosis treatment platform as recited in claim 1, further comprising:
a first strap connected to one or more of the seat, the leg structures, and the at least one frame member, the first strap configured to extend around the patient and apply a specified force to a first specified anatomical portion of the patient when the patient is seated on the seat; and
a second strap connected to one or more of the seat, the leg structures, and the at least one frame member, the second strap configured to extend around the patient and apply a specified force to a second specified anatomical portion of the patient when the patient is seated on the seat.

29. The scoliosis treatment platform as recited in claim 28, wherein the first and second specified anatomical portions of the patient are on opposite lateral sides of the patient.

30. The scoliosis treatment platform as recited in claim 28, wherein the first and second specified anatomical portions of the patient are on a same lateral side of the patient.

31. The scoliosis treatment platform as recited in claim 28, wherein a portion of the first strap that contacts the patient is fitted with a padding material, such that the padding material is positioned between the first strap and the patient.

32. The scoliosis treatment platform as recited in claim 31, wherein a portion of the second strap that contacts the patient is fitted with a padding material, such that the padding material is positioned between the second strap and the patient.

33. The scoliosis treatment platform as recited in claim 28, further comprising:
a first ratcheting lever connected to one or more of the seat, the leg structures, and the at least one frame member, the first ratcheting lever configured to provide for tightening of the first strap to apply the specified force to the first specified anatomical portion of the patient when the patient is seated on the seat; and
a second ratcheting lever connected to one or more of the seat, the leg structures, and the at least one frame member, the second ratcheting lever configured to provide for tightening of the second strap to apply the specified force to the second specified anatomical portion of the patient when the patient is seated on the seat.

34. The scoliosis treatment platform as recited in claim 1, wherein the scoliosis treatment platform is configured to be tilted in a controlled manner relative to horizontal when the patient is seated on the seat.

35. The scoliosis treatment platform as recited in claim 34, wherein the scoliosis treatment platform is configured to be rotated in a controlled manner about a central axis of rotation that extends in a direction substantially perpendicular to a plane of the seat when the patient is seated on the seat.
